(19) United States
(12) Patent Application Publication
(10) Pub. No.: US 2025/0342695 A1
(43) Pub. Date: Nov. 6, 2025

(54) ACTIVE REGION VIDEO DIFFUSION FOR UNIVERSAL POLICIES

(71) Applicant: NVIDIA Corporation, Santa Clara, CA (US)

(72) Inventors: Shuaiyi Huang, Rockville, MD (US); Zhenyu Jiang, Austin, TX (US); Yuke Zhu, Austin, TX (US); Jim Fan, San Jose, CA (US); De-An Huang, Cupertino, CA (US)

(21) Appl. No.: 19/064,534

(22) Filed: Feb. 26, 2025

Related U.S. Application Data
(60) Provisional application No. 63/641,329, filed on May 1, 2024.

(51) Int. Cl. G06V 20/40

(52) U.S. Cl. CPC G06V 20/44; G06V 20/46

(57) ABSTRACT

One critical objective of robotic learning is building a universal agent capable of performing a vast number of tasks across a diverse set of environments. Currently, an agent policy for performing a task can be learned from video depicting performance of the task. However, because the learning is susceptible to focusing on areas of the video that do not depict the actual performance of the task, errors can be introduced into the policy. The present disclosure provides video diffusion for a specified task with a focus on an active region in which the task is being performed, such that an agent policy then trained on the video will correctly learn the actions needed to be taken to perform the task.

### CLAIM OF PRIORITY

This application claims the benefit of U.S. Provisional Application No. 63/641,329 (Attorney Docket No. NVIDP1401+/24-SC-0525US01) titled “ACTIVE REGION VIDEO DIFFUSION FOR UNIVERSAL POLICIES,” filed May 1, 2024, the entire contents of which is incorporated herein by reference.

### TECHNICAL FIELD

The present disclosure relates to diffusion-based video generation.

### BACKGROUND

One critical objective of robotic learning is building a universal agent capable of performing a vast number of tasks across a diverse set of environments. Achieving this goal is challenging as the definition of a particular state or action may vary based on the task description. For instance, the state and action space of a robot tasked with navigating through a cluttered warehouse is differently defined than a robot whose purpose is to assemble intricate machinery. These variations demand a policy for the agent that not only provides a universal representation of the state space but also precisely identifies the actions necessary for any given task.

One existing solution includes jointly using video and text descriptions to define a generalized state and action space. In this solution, a video generator is employed as a planner, which produces a sequential trajectory of frames as states given a text description of the immediate goal and an initial visual representation of the environment. Once the trajectory is generated, a policy conditioned on this trajectory (sequence of frames) is learned to infer the action taken between adjacent frames. The intuition is that using videos to represent the state space enables greater generalization across various tasks and environments.

Recently, there has been considerable progress made in this field, with notable works demonstrating success in tasks such as robot navigation and manipulation. However, these methods often struggle to solve the task because they generate videos treating all pixels uniformly, often focusing on the wrong areas and neglecting to model pixels that are important for the policy. This can result in errors in generated frames, and ultimately cause the policy to learn incorrect actions for a given task.

There is a need for addressing these issues and/or other issues associated with the prior art. For example, there is a need to provide video diffusion with a focus on an active region that represents an area where objects are being interacted with, such that a policy trained on the video gives attention to those objects.

### SUMMARY

A method, computer readable medium, and system are disclosed for video diffusion. A video frame capturing an object and a text prompt describing a task to be performed by the object are processed, using an active region diffusion model, to predict a region of the video frame that is active with respect to performance of the task. The video frame, the text prompt and the region of the video frame predicted to be active with respect to performance of the task are processed, using a video diffusion model, to generate a sequence of video frames depicting the object performing the task.

### BRIEF DESCRIPTION OF THE DRAWINGS

FIG. 1 illustrates a flowchart of a method for video diffusion, in accordance with an embodiment.

FIG. 2A illustrates a system pipeline for video diffusion, in accordance with an embodiment.

FIG. 2B illustrates a flow diagram for training the active region diffusion model of FIG. 2A, in accordance with an embodiment.

FIG. 2C illustrates a flow diagram for video diffusion using the system pipeline of FIG. 2A, in accordance with an embodiment.

FIG. 3A illustrates a system pipeline for creating a policy from a video, in accordance with an embodiment.

FIG. 3B illustrates a flow diagram for creating a policy using the system pipeline of FIG. 3A, in accordance with an embodiment.

FIG. 4A illustrates a method for creating a policy, in accordance with an embodiment.

FIG. 4B illustrates a method for controlling a robot using a policy, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

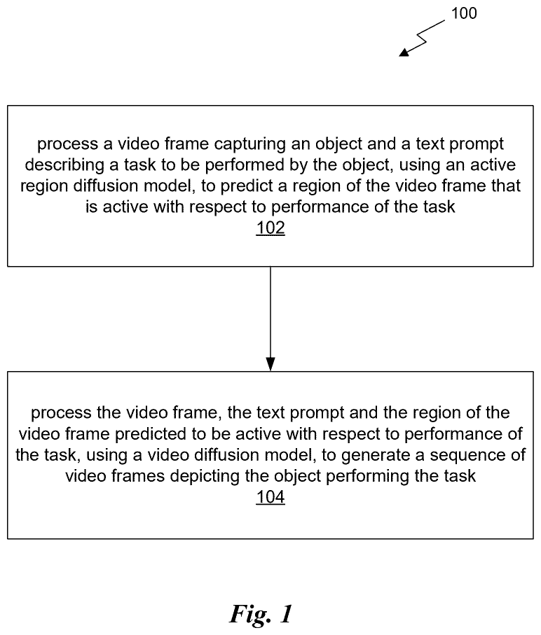

FIG. 1 illustrates a flowchart of a method 100 for video diffusion, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In the context of the present description, video diffusion refers to the generation of a video comprised of a plurality of video frames. The video frames are generated by a video diffusion model from an input video frame. As described herein, the diffusion model is conditioned to focus the video generation on the depiction of a particular task (e.g. activity) specified in a text prompt as well as on a particular region of the input video frame that is predicted to correspond to the task.

Returning to the method 100, in operation 102, a video frame capturing an object and a text prompt describing a task to be performed by the object are processed, using an active region diffusion model, to predict a region of the video frame that is active with respect to performance of the task. The video frame refers to a static image of an object. In an embodiment, the video frame is a single frame (image). In an embodiment, the video frame is selected, generated, or otherwise provided as input for the purpose of generating a video therefrom, as described herein.

The text prompt refers to a text that describes the task that is to be depicted in the video as being performed by the object depicted in the video frame. In an embodiment, object depicted in the video frame may be a robot and the task may be a robotics task. For example, the object depicted in the video frame may be a robot with an articulated arm and the task may be an operation of the articulated arm (e.g. assembling, packing, picking and placing, and/or any other operation capable of being performed by an articulated robot). As another example, the object depicted in the video frame may be an autonomous vehicle and the task may be an autonomous driving operation (e.g. turning, changing lanes, parking, etc.).

Further, the active region diffusion model refers to a diffusion model that is trained using machine learning to predict a region of a given video frame that is active with respect to a task described by a given text prompt. In an embodiment, the active region diffusion model may be trained with supervision. For example, the supervised training may use a dataset of training videos each labeled with an indication of a depicted task and each comprised of an initial video frame labeled with a ground truth representation of an active region in the initial video frame that corresponds to the depicted task.

In an embodiment, the ground truth active region representations may be pseudo ground truths. For example, each training video in the dataset of training videos may be labeled with the ground truth representation of the active region (i.e. the pseudo ground truth) by using one or more machine learning models. This labeling may be performed by, in part, determining, using a dense point tracking model, points in the initial video frame that have movement in subsequent video frames corresponding to the depicted task. In an embodiment, determining the points in the initial video frame that have movement in subsequent video frames corresponding to the depicted task may include using the dense point tracking model to obtain dense point trajectories across a plurality of video frames of the training video, detecting moving point trajectories from the dense point trajectories based on a movement threshold, and determining the points in the initial video frame that correspond to the moving point trajectories. In an embodiment, the points in the initial video frame may be defined by their coordinates in the initial video frame.

The labeling may further be performed by processing the points in the initial video frame, by a segmentation model, to generate for the initial video frame a mask defining the active region in the initial video frame that corresponds to the depicted task, and then encoding the mask into the ground truth representation of the active region in the initial video frame that corresponds to the depicted task. In an embodiment, the ground truth representation of the active region may be a latent representation of the active region.

In an embodiment, the active region diffusion model may be a conditional diffusion model. For example, in the present embodiment, the active region diffusion model may be conditioned on the text prompt to predict the region (e.g. portion, pixels, etc.) of the video frame, also referred to herein as the “active region”, that depicts the task being performed at a moment in time. In an embodiment, the active region includes the object depicted in the video frame which the text prompt describes as performing the task. In an embodiment, the active region may also include one or more other objects depicted in the video frame which the text prompt describes as being interacted with by the object when performing the task. In an embodiment, the region of the video frame predicted to be active with respect to performance of the task may be defined as a latent representation of the region of the video frame.

In operation 104, the video frame, the text prompt and the region of the video frame predicted to be active with respect to performance of the task are processed, using a video diffusion model, to generate a sequence of video frames depicting the object performing the task. With respect to the present description, a video may be comprised of the sequence of video frames, or in other words the video diffusion model may generate the video as the sequence of video frames. The sequence of video frames generated by the video diffusion model may follow, time-wise, the given video frame, in an embodiment.

The video diffusion model refers to a diffusion model that is trained to generate a sequence of video frames from a given video frame and a given text prompt describing the task to be depicted in the sequence of video frames. In the present embodiment, the video diffusion model is also conditioned on the region of the video frame predicted to be active with respect to performance of the task. Thus, the region of the video frame predicted to be active with respect to performance of the task may guide the video diffusion model to generate the sequence of video frames depicting the object performing the task. This guidance may constrain the generation of video frames by the video diffusion model to the “active region” and thereby focus the generated video frames to that region. As a result, other regions of the given video frame may be excluded in the generated video frames.

In an embodiment, each video frame in the sequence of video frames may be defined as a latent representation of the video frame. In an embodiment, each video frame in the sequence of video frames may be defined as a RGB (red, green, blue) representation of the video frame.

In an embodiment, the video diffusion model may concatenate a latent representation of the video frame with a latent representation of the region of the video frame predicted to be active with respect to performance of the task, and may further concatenate a latent representation of each generated video frame in the sequence of video frames with the latent representation of the region of the video frame predicted to be active with respect to performance of the task. These frame-by-frame concatenated latent representations may be the output of the video diffusion model.

As described above, the method 100 provides video diffusion from a given video frame which is constrained by both a text prompt describing a task to be depicted by the video as well as a task-specific “active region” of the given video frame. This method 100 focuses the video diffusion on the active region, for example to exclude from the newly generated video frames other regions of the given video frame that are meaningless with respect to depicting the task. In a further embodiment to the method 100, the video, or sequence of video frames, generated via the method 100 may be output for various purposes.

In an embodiment, the sequence of video frames may be output for display thereof as a video. In an embodiment, the sequence of video frames may be output for use in generating a policy for performing the task. The policy refers to a set of rules or strategies that defines the decision-making process of an agent (i.e. a real-world instance of the object) to perform the task. Given an input state, the policy may be configured to generate the action to be taken by the real-world object.

For example, the sequence of video frames depicting the object performing the task may be processed, by an inverse model, to determine one or more actions to take to perform the task. As a result of the video being focused to the task, per the method 100, the actions determined from such video may likewise be focused to the task. In an embodiment, the policy may be defined as state-action pairs each defining an action to take at a given state. In an embodiment, each video frame in the sequence of video frames may be defined as a latent representation of the video frame and in this case the inverse model may be configured to process the latent representations of the video frames in the sequence of video frames to determine the one or more actions to take to perform the task.

In a further embodiment to the method 100, a real-world object depicted by the object in the video frame may be caused to perform the one or more actions. This may be accomplished by outputting the policy to the real-world object. For example, the real-world object may perform the task using the policy. Just by way of example, a real-world robot may be caused to perform a robotics task defined by the policy. As another example, a real-world autonomous vehicle may be caused to perform an autonomous driving task defined by the policy.

In one exemplary implementation of the method 100, video diffusion may be provided for use in learning a policy. In particular, for an input video frame capturing an object and for an input text prompt describing a task to be performed by the object, an active region of the video frame that depicts the object performing the task is predicted by an active region diffusion model (e.g. per operation 102). In an embodiment the object may be a robot and the task may be a robotics task. In another embodiment, the object may be an autonomous vehicle and the task may be an autonomous driving task. In an embodiment, wherein the input video frame may be a single video frame. In an embodiment, the active region of the video frame may be defined as a latent representation of the active region of the video frame.

Also with respect to the exemplary implementation, based on the video frame, the text prompt and the active region of the video frame, a video comprised of a plurality of video frames that sequentially depict the object performing the task is generated by a video diffusion model (e.g. per operation 104). In an embodiment, the active region of the video frame may guide the video diffusion model to generate the plurality of video frames that sequentially depict the object performing the task. In an embodiment, each video frame in the plurality of video frames may be defined as a latent representation of the video frame or as a RGB representation of the video frame.

Additionally, with respect to the exemplary implementation, a policy for performing the task is learned from the video by an inverse model. In an embodiment, the policy may be comprised of one or more actions to take to perform the task. In an embodiment, the policy may be comprised of state-action pairs each defining an action for the object to take when in a corresponding state.

Further, with respect to the exemplary implementation, a real-world instance of the object is further caused to use the policy to perform the task. In an embodiment, the real-world instance of the object may be a robot operating in a real-world environment and the task may be a robotics task. For example, the robotics task may include movement (e.g. relocation) by the robot of a second object in the real-world environment. In another embodiment, the real-world instance of the object may be an autonomous vehicle operating in a real-world environment and the task may be an autonomous driving task.

Further embodiments will now be provided in the description of the subsequent figures. It should be noted that the embodiments disclosed herein with reference to the method 100 of FIG. 1 may apply to and/or be used in combination with any of the embodiments of the remaining figures below.

A Unified Predictive Decision Process (UPDP) aims to provide a solution for sequential decision-making problems by (1) using video as the state space, (2) utilizing text-to-image understanding to use text to define the goal instead of an arbitrary reward and (3) developing a task-agnostic planning algorithm to find the action instead of relying on a predefined dynamics model. These three features enable UPDPs to scale across a wide variety of tasks.

Formally, a UPDP is a tuple G=(X, C, H, ρ), where X is the observation space and each x₀, x₁, . . . , x_{H} ε X is an RGB frame, C is the set of task descriptions, H is the task length and ρ(·|x₀, c) is a conditional video generator that synthesizes an H-step video

$${\{ {x}_{h} \}}_{h = 1}^{H} ∈ Δ ( {X}^{H} ) ,$$

where x₁, x₂, . . . , x_{H} are predicted future frames conditioned on the first ground truth frame x₀ and the task description c.

Given a UPDP G, an action prediction algorithm is defined as

$$μ ( \cdot \vert {\{ {x}_{h} \}}_{h = 0}^{H} , c ) \to Δ ( {A}^{H} ) ,$$

where A^{H} represents an H-step action. This algorithm outputs an action sequence that aligns with the provided trajectory

$${\{ {x}_{h} \}}_{h = 1}^{H}$$

in the UPDP G for the task c. This algorithm is trained offline assuming access to a dataset of existing experiences

$$D = \{ {( {x}_{i} , {a}_{i} )}_{i = 0}^{H - 1} , {x}_{H} , c \} .$$

Given D, ρ(·|x₀, c) and

$$π ( \cdot \vert {\{ {x}_{h} \}}_{h = 0}^{H} , c )$$

can be estimated.

In the UPDP framework, the success of a task heavily relies on the action prediction algorithm,

$$μ ( \cdot \vert {\{ {x}_{h} \}}_{h = 0}^{H} , c ) .$$

The action prediction, in turn, is conditioned on the images generated in the video generation stage. However, not all pixels generated in the video have an equal impact on the action. Active regions, which are typically objects that are the most likely to be interacted with, are more likely to have an impact on the action. By prioritizing focus on generation of the active regions, the predicted actions can be better aligned with the task description c.

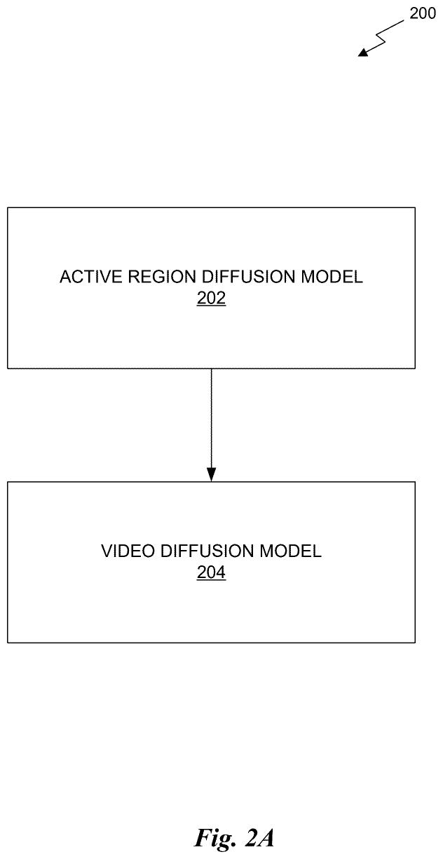

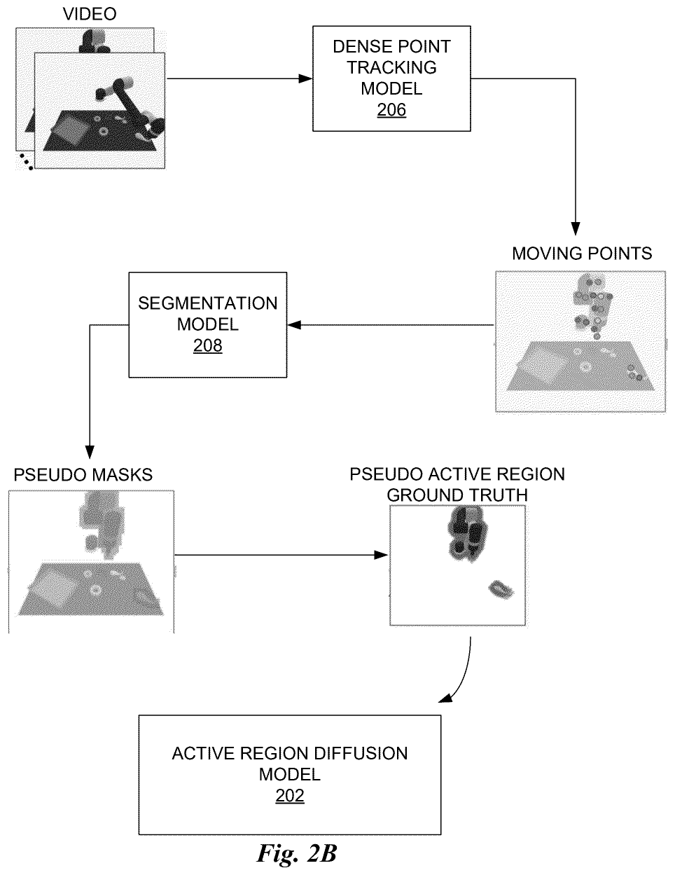

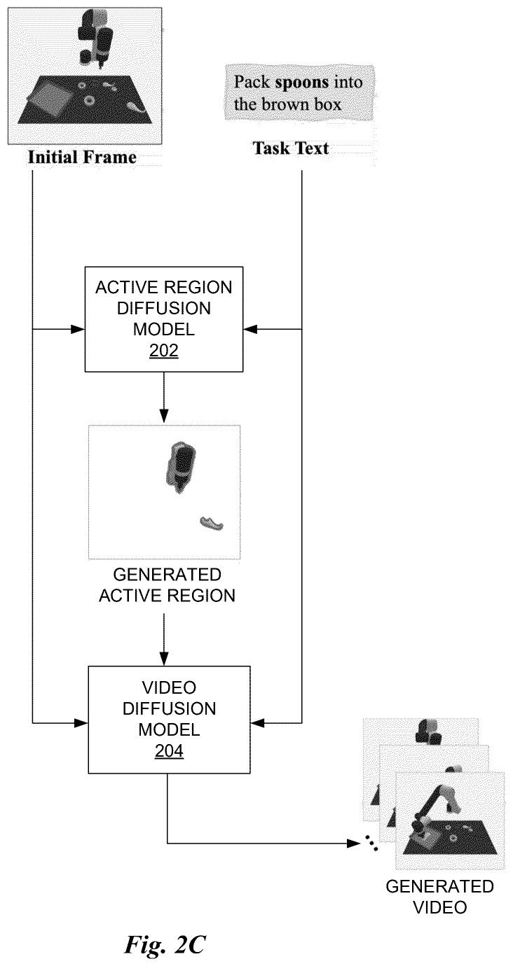

FIG. 2A illustrates a system pipeline 200 for video diffusion, which in an embodiment represents an enhanced version of UPDP, also referred to herein as LUPDP-AR (Latent Unified Predictive Decision Process conditioned on Active Region). LUPDP-AR introduces active region conditioning to a video diffusion model 204 to foster a more interaction-aware policy.

Formally, an LUPDP-AR is defined as a tuple Ĝ=(\hat{X}, C, Ô, H, Ø), where \hat{X} and Ô represent the latent spaces for RGB frames and active region frames, respectively. A frame encoder E(·) is adopted to map both RGB frames and active regions into these latent spaces. Ø is a latent conditional video diffusion model 204 that synthesizes an H-step latent trajectory

$${\{ {\hat{x}}_{h} \}}_{h = 1}^{H} ∈ Δ ( {\hat{X}}^{H} ) .$$

To ensure the accuracy of the active region in the generated trajectory, the video diffusion model 204 is conditioned on the active region of the initial frame. Unlike the original UPDP, LUPDP-AR conditions on the latent representation of the active region ô ε Ô as well as the latent of the initial frame \hat{x}₀ ε \hat{X} and the task description c, instead of conditioning on just the original frame x₀ and the task description c. This new video diffusion model 204 is defined as Ø(·|\hat{x}₀, c, ô). Conditioning on active regions focuses the video generation process leading to more accurate actions for task completion.

To capture the active region in the initial frame, an active region diffusion model 202 is defined as ψ(ô|\hat{x}₀, c): \hat{X}×C→Ô, which generates the latent of the active region ô based on the latent of the first frame \hat{x}₀ and the task description c. This methodology decomposes the challenging trajectory generation by generating the active region of the initial frame first, followed by the generation of the full sequence under the guidance of the active region.

Given an LUPDP-AR Ĝ, a latent conditioned action prediction algorithm

$$π ( \cdot \vert {\{ {\hat{x}}_{h} \}}_{h = 0}^{H} , c ) \to Δ ( {A}^{H} ) ,$$

where A^{H} represents an H-step action sequence. In an embodiment, π only requires the latent of the generated images as input. This eliminates the need to generate RGB frames or decode a latent image. A decoder, R, can be used to visually interpret the results, but in some embodiments this may not be necessary for the action generation.

FIG. 2B illustrates a flow diagram for training the active region diffusion model 202 of FIG. 2A, in accordance with an embodiment.

To train the active region diffusion model 202 without manual labeling, an active region dataset Dₒ={\hat{x}₀, c, ô) is constructed from video demonstrations by a large pre-trained dense point tracking model 206 to pinpoint areas of significant activity throughout the episode. By doing so, pseudo masks for active regions can be identified in each initial frame from D.

Formally, given a video

$$V = {\{ {x}_{h} \}}_{h = 0}^{H} ,$$

dense point urajeciones P are obtained through a dense point tracking model 206 Fₚ. In one embodiment, the dense point tracking model 206 may be Co-Tracker which is pretrained on real-world videos. Co-Tracker divides the initial frame into an M×M grid and tracks each point across H+1 frames. The obtained dense point trajectories set is denoted as P=Fₚ(V), where |P|=M×M is the size of all dense point trajectories. Each point trajectory consists of a single point's location from timestep 0 to H.

Given all point trajectories P, the moving point trajectories are found by analyzing the change in pixel location. For each point trajectory p ε P, the absolute movement Δpₕ between two adjacent frames at timestep h and h−1 is computed per Equation 1.

$$Δ {p}_{h} = {‖ {p}_{h} - {p}_{h - 1} ‖}_{2} , for h = 1 , … , H \qquad Equation 1$$

where pₕ and pₕ₋₁ are the point coordinates at time h and h−1, respectively. The average movement Δp̅ of a point trajectory over H timesteps is given by Equation 2.

$$Δ \overline{p} = \frac{1}{H} {\sum }_{h = 1}^{H} Δ {p}_{h} \qquad Equation 2$$

To identify moving point trajectories that exhibit significant displacement, a selection criterion is applied based on τ an average movement threshold, denoted by τ per Equation 3.

$${P}_{m} = \{ p ∈ P \vert Δ \overline{p} > τ \qquad Equation 3$$

where τ is a pre-selected threshold. Pₘ denotes the set of selected points whose average movement exceeds τ. Coordinates of these points at the initial frame are then obtained from Pₘ and this set is denoted as P₀.

To generate the pseudo masks M for the active region at the initial frame, the initial frame x₀ is fed into the segmentation anything model (SAM) 208 and SAM is prompted with the coordinates at the initial frame P₀.

Given the derived pseudo mask M of the active regions, the pseudo active region frame o at the initial frame x₀ is defined per Equation 4.

$$o = {x}_{0} ∘ M + {x}_{b} ∘ ( 1 - M ) \qquad Equation 4$$

where ∘ is element-wise multiplication and x_{b} is a background frame with entirely white pixels. This process bypasses the need for manual labeling. Finally, the pretrained image encoder E from Stable Diffusion is applied to generate the latent representation of the active region ô.

Once the dataset Dₒ is constructed, an active region diffusion model 202 is defined (i.e. trained) to identify the active region at test time. ARDuP adopts a conditioned latent active region diffusion model 202 ψ(ô|\hat{x}₀, c; θ_{ψ}) to accomplish this. The active region diffusion model 202 takes as input both a textual description of a task and the latent representation of the initial frame and outputs the active region. Both inputs are used because only together can the model 202 accurately pinpoint areas of potential interaction. Without the frame, the active region diffusion model 202 would not know where items are positioned and without the text description the model would not understand the context of the task.

Diffusion models are flexible, which enables the active region diffusion model 202 to select many possible active regions. This flexibility is important because there are often many ways to complete a task and thus the active region diffusion model 202 will encompass this uncertainty. For example, in a task described as “put blue blocks into the box”, any unplaced blue block can be identified as a valid active region. This flexibility is particularly beneficial in dynamic environments where multiple paths to task completion may exist.

FIG. 2C illustrates a flow diagram for video diffusion using the system pipeline 200 of FIG. 2A, in accordance with an embodiment.

The video diffusion model 204 serves as the trajectory planner. This video diffusion model 204 is designed to accurately generate future video latent representations based on an initial frame and a textual description of the task at hand as well as the active region.

The video diffusion model 204, Ø(·|\hat{x}₀, c, ô; θ_{Ø}), integrates the active region

alongside the initial frame and text description for conditioning. By guiding the video diffusion model 204 with the active region, it can focus its generation efforts on areas crucial to the described task, enhancing the relevance and precision of the generated sequence.

To perform this integration, each frame's latent is concatenated with the latent of the active region ô. This is one in addition to the concatenation of the active region latent with the latent of the initial frame \hat{x}₀. This dual concatenation strategy ensures that the video diffusion model's 204 denoising process for each frame aligns not only with the initial observation but also with the active region latents.

During inference, the input active region of Ø(·|\hat{x}₀, c, ô; θ_{Ø}) is generated from the trained active region diffusion model 202 ψ(ô|\hat{x}₀, c; θ_{ψ}) given input text and initial frame. During training of Ø(·|\hat{x}₀, c, ô; θ_{Ø}), the input active region is obtained from the training videos as detailed above. During inference, the generated active region, along with the provided text and initial frame, is then input into the video diffusion model 204 ϕ(·|\hat{ }x0, c, \hat{ }o; θϕ) for generating the latent sequence.

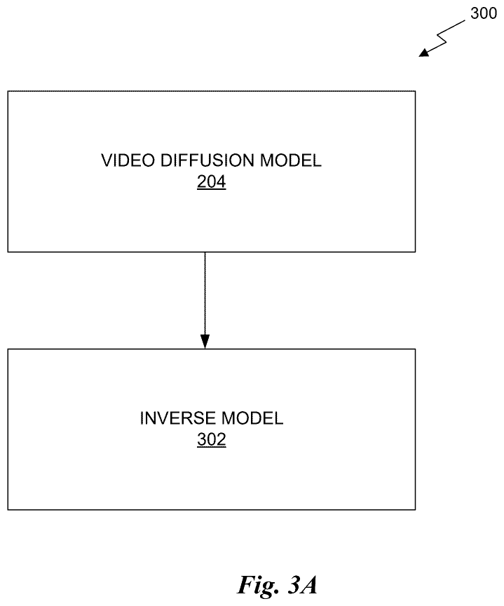

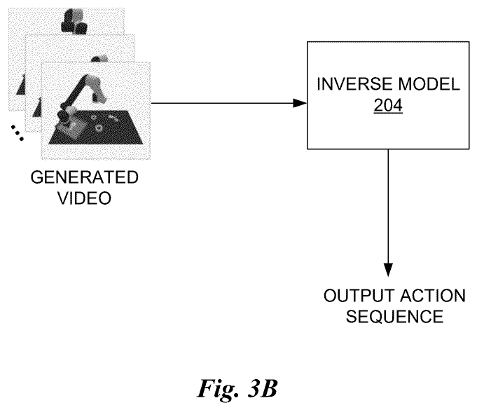

FIG. 3A illustrates a system pipeline 300 for creating a policy from a video, in accordance with an embodiment.

A compact, task-specific inverse model 302, also referred to herein as a latent inverse dynamics model, is trained to convert synthesized latent sequences from the video diffusion model 204 directly into action sequences which represent a policy, also referred to herein as a universal agent policy. Given two adjacent generated frame latents \hat{x}ₕ and \hat{x}ₕ₊₁, the inverse model 302 predicts the action aₕ. The training of the inverse model 302 is independent of the video diffusion model 204 and in an embodiment can be done on a separate, smaller, and potentially suboptimal dataset generated by a simulator. Both the video diffusion model 204 and the inverse model 302 utilize the same encoder E to map the RGB frame into the latent space. This ensures a consistent latent embedding space for both the video generation and the action decoding phases.

FIG. 3B illustrates a flow diagram for creating a policy using the system pipeline 300 of FIG. 3A, in accordance with an embodiment.

During inference, actions are decoded by the inverse model 302, for example directly from latent frames. Decoding from latent frames represents a significant advancement over the existing RGB-based inverse dynamic models, which rely on RGB frames for action decoding. A main challenge with training video diffusion models to output RGB frames directly is the computational cost. The latent inverse model 302, on the other hand, bypasses the need to generate RGB frames because it can compute the action directly from the latent. This strategy not only streamlines the decoding process but also makes ARDuP's architecture more efficient and compact. In an embodiment, however, the decoder R can be employed to transform these synthesized latents back into RGB frames if desired.

In an embodiment, the system pipeline 300 may be implemented in combination with the system pipeline 200 of FIG. 2. The flow of such combined pipelines during the execution phase may then be described as follows:

Staring with xₒ and c, generate the active region latent ô by active region diffusion model 202, followed by the synthesis of a H-step latent sequence by video diffusion model 204. Feed the generated latents into the trained inverse model 302 to produce the corresponding H actions. To enhance computational efficiency, employ an open-loop control strategy by sequentially performing actions from the initially predicted action sequence.

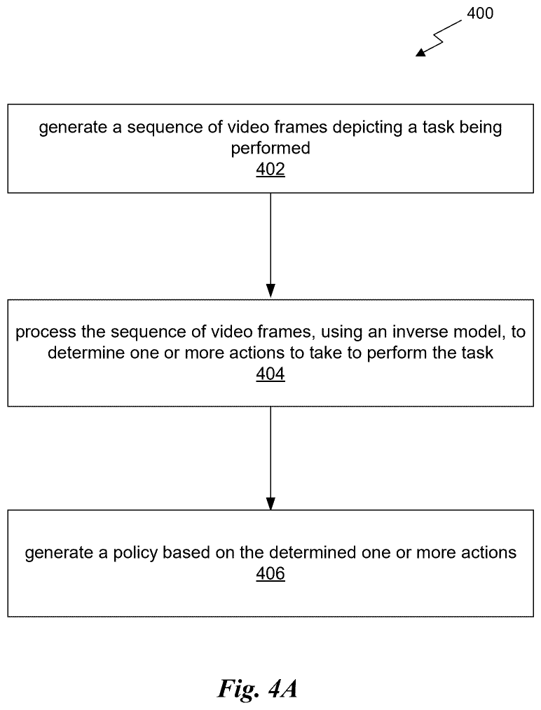

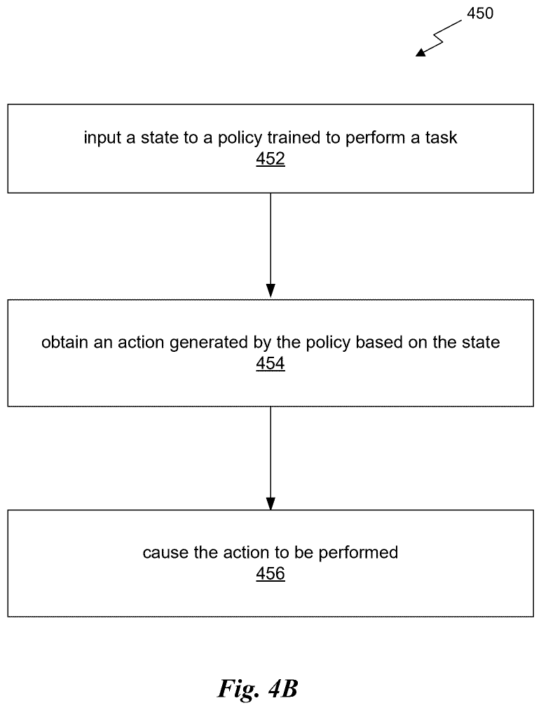

FIG. 4A illustrates a method 400 for creating a policy, in accordance with an embodiment. The method 400 may be carried out by the system pipelines 200, 300 of FIGS. 2A and 3A respectively.

In operation 402, a sequence of video frames depicting a task being performed are generated. The sequence of video frames may be generated using the system pipeline 200 of FIG. 2A, as described above. The sequence of video frames may be represented in a latent space.

In operation 404, the sequence of video frames are processed, using an inverse model, to determine one or more actions to take to perform the task. The one or more actions may be determined using the system pipeline 300 of FIG. 3A, as described above.

In operation 406, a policy is generated based on the determined one or more actions. In an embodiment, the policy may define the one or more actions as instructions. In an embodiment, the policy may define the one or more actions in state-action pairs.

FIG. 4B illustrates a method 450 for controlling a robot using a policy, in accordance with an embodiment. The robot may be a robot with an articulated arm or an autonomous driving vehicle, for example. In the present embodiment, the policy may refer to the policy comprised of state-action pairs as generated via the method 400 of FIG. 4.

In operation 400, a state is input to a policy trained to perform a task. The state refers to a current (e.g. positional) state of the robot. In operation 402, an action generated by the policy based on the state is obtained. For example, an action that corresponds to the state may be retrieved from the policy. In operation 406, the action is caused to be performed. In particular, the robot is controlled (e.g. instructed) to perform the action.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

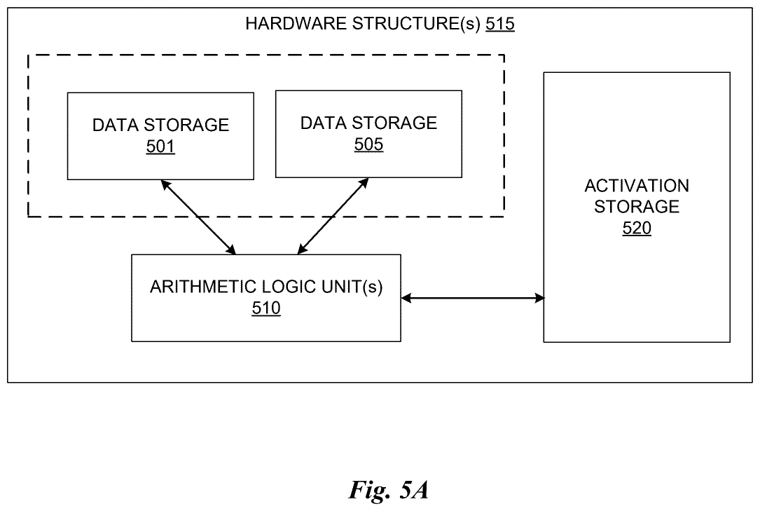

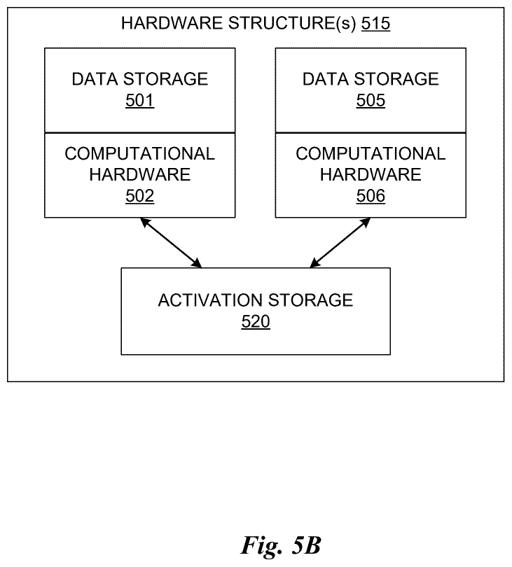

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

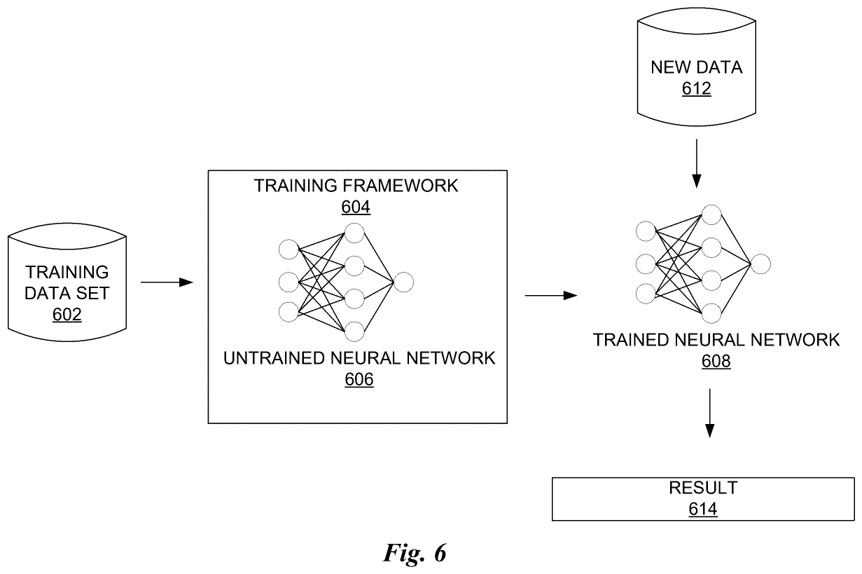

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

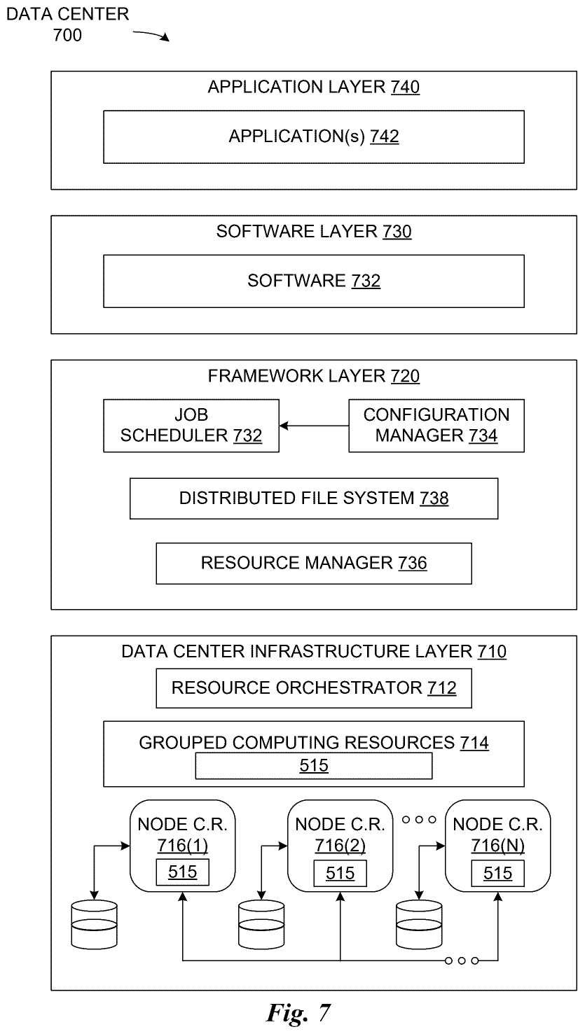

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide a video diffusion. In accordance with FIGS. 1-4B, embodiments may provide one or more diffusion models usable for performing inferencing operations and for providing inferenced data. The diffusion models may be stored (partially or wholly) in one or both of data storage 501 and 505 in inference and/or training logic 515 as depicted in FIGS. 5A and 5B. Training and deployment of the diffusion models may be performed as depicted in FIG. 6 and described herein. Distribution of the diffusion models may be performed using one or more servers in a data center 700 as depicted in FIG. 7 and described herein.

What is claimed is:

1. A method, comprising:
at a device:
for an input video frame capturing an object and for an input text prompt describing a task to be performed by the object, predicting, by an active region diffusion model, an active region of the video frame that depicts the object performing the task;
generating, by a video diffusion model based on the video frame, the text prompt and the active region of the video frame, a video comprised of a plurality of video frames that sequentially depict the object performing the task;
learning, by an inverse model from the video, a policy for performing the task; and
causing a real-world instance of the object to use the policy to perform the task.

2. The method of claim 1, wherein the object is a robot and the task is a robotics task.

3. The method of claim 1, wherein the object is an autonomous vehicle and the task is an autonomous driving task.

4. The method of claim 1, wherein the input video frame is a single video frame.

5. The method of claim 1, wherein the active region of the video frame is defined as a latent representation of the active region of the video frame.

6. The method of claim 1, wherein the active region of the video frame guides the video diffusion model to generate the plurality of video frames that sequentially depict the object performing the task.

7. The method of claim 1, wherein each video frame in the plurality of video frames is defined as a latent representation of the video frame.

8. The method of claim 1, wherein each video frame in the plurality of video frames is defined as a RGB representation of the video frame.

9. The method of claim 1, wherein the policy is comprised of one or more actions to take to perform the task.

10. The method of claim 1, wherein the policy is comprised of state-action pairs each defining an action for the object to take when in a corresponding state.

11. The method of claim 1, wherein the real-world instance of the object is a robot operating in a real-world environment and wherein the task is a robotics task.

12. The method of claim 11, wherein the robotics task includes movement by the robot of a second object in the real-world environment.

13. The method of claim 1, wherein the real-world instance of the object is an autonomous vehicle operating in a real-world environment and wherein the task is an autonomous driving task.

14. A method, comprising:
at a device:
processing a video frame capturing an object and a text prompt describing a task to be performed by the object, using an active region diffusion model, to predict a region of the video frame that is active with respect to performance of the task;
processing the video frame, the text prompt and the region of the video frame predicted to be active with respect to performance of the task, using a video diffusion model, to generate a sequence of video frames depicting the object performing the task.

15. The method of claim 14, wherein the active region diffusion model is a conditional diffusion model.

16. The method of claim 14, wherein the active region diffusion model is trained with supervision using a dataset of training videos each labeled with an indication of a depicted task and each comprised of an initial video frame labeled with a ground truth representation of an active region in the initial video frame that corresponds to the depicted task.

17. The method of claim 16, wherein each training video in the dataset of training videos is labeled with the ground truth representation of the active region by:
determining, using a dense point tracking model, points in the initial video frame that have movement in subsequent video frames corresponding to the depicted task, and
processing the points in the initial video frame, by a segmentation model, to generate for the initial video frame a mask defining the active region in the initial video frame that corresponds to the depicted task, and
encoding the mask into the ground truth representation of the active region in the initial video frame that corresponds to the depicted task.

18. The method of claim 17, wherein determining the points in the initial video frame that have movement in subsequent video frames corresponding to the depicted task includes:
using the dense point tracking model to obtain dense point trajectories across a plurality of video frames of the training video,
detecting moving point trajectories from the dense point trajectories based on a movement threshold,
determining the points in the initial video frame that correspond to the moving point trajectories.

19. The method of claim 18, wherein the points in the initial video frame are defined by their coordinates in the initial video frame.

20. The method of claim 16, wherein the ground truth representation of the active region is a latent representation of the active region.

21. The method of claim 14, wherein the region of the video frame predicted to be active with respect to performance of the task is defined as a latent representation of the region of the video frame.

22. The method of claim 14, wherein the region of the video frame predicted to be active with respect to performance of the task guides the video diffusion model to generate the sequence of video frames depicting the object performing the task.

23. The method of claim 14, wherein the video diffusion model concatenates a latent representation of the video frame with a latent representation of the region of the video frame predicted to be active with respect to performance of the task, and further concatenates a latent representation of each generated video frame in the sequence of video frames with the latent representation of the region of the video frame predicted to be active with respect to performance of the task.

24. The method of claim 14, wherein the method further comprises, at the device:
outputting the sequence of video frames.

25. The method of claim 24, wherein each video frame in the sequence of video frames is defined as a latent representation of the video frame.

26. The method of claim 24, wherein each video frame in the sequence of video frames is defined as a RGB representation of the video frame.

27. The method of claim 24, wherein the method further comprises, at the device:
processing the sequence of video frames depicting the object performing the task, by an inverse model, to determine one or more actions to take to perform the task.

28. The method of claim 27, wherein each video frame in the sequence of video frames is defined as a latent representation of the video frame and wherein the inverse model is configured to process the latent representations of the video frames in the sequence of video frames to determine the one or more actions to take to perform the task.

29. The method of claim 27, wherein the method further comprises, at the device:
causing a real-world object depicted by the object in the video frame to perform the one or more actions.

30. The method of claim 29, wherein the real-world object is a robot and wherein the task is a robotics task.

31. The method of claim 29, wherein the real-world object is an autonomous vehicle and wherein the task is an autonomous driving task.

32. A system, comprising:
a non-transitory memory storage comprising instructions; and
one or more processors in communication with the memory, wherein the one or more processors execute the instructions to:
process a video frame capturing an object and a text prompt describing a task to be performed by the object, using an active region diffusion model, to predict a region of the video frame that is active with respect to performance of the task;
process the video frame, the text prompt and the region of the video frame predicted to be active with respect to performance of the task, using a video diffusion model, to generate a sequence of video frames depicting the object performing the task.

33. The system of claim 32, wherein the region of the video frame predicted to be active with respect to performance of the task guides the video diffusion model to generate the sequence of video frames depicting the object performing the task.

34. The system of claim 32, wherein the one or more processors further execute the instructions to:
learn, by an inverse model from the sequence of video frames, a policy for performing the task; and
cause a real-world instance of the object to use the policy to perform the task.

35. A non-transitory computer-readable media storing computer instructions which when executed by one or more processors of a device cause the device to:
process a video frame capturing an object and a text prompt describing a task to be performed by the object, using an active region diffusion model, to detect a region of the video frame predicted to be active with respect to performance of the task;
process the video frame, the text prompt and the region of the video frame predicted to be active with respect to performance of the task, using a video diffusion model, to generate a sequence of video frames depicting the object performing the task.

36. The non-transitory computer-readable media of claim 35, wherein the region of the video frame predicted to be active with respect to performance of the task guides the video diffusion model to generate the sequence of video frames depicting the object performing the task.

37. The non-transitory computer-readable media of claim 35, wherein the one or more processors further cause the device to:
learn, by an inverse model from the sequence of video frames, a policy for performing the task; and
cause a real-world instance of the object to use the policy to perform the task.
